(19) United States
(12) Patent Application Publication
(10) Pub. No.: US 2026/0018349 A1
(43) Pub. Date: Jan. 15, 2026

(54) Wall station with adjustable position keypad

(71) Applicant: SIGNIFY HOLDING B.V., EINDHOVEN (NL)

(72) Inventors: VOYA VIDAKOVIC, MARIETTA, GA (US); PHILIP DEAN WINTERS, CENTRE, AL (US)

(21) Appl. No.: 18/996,669

(22) PCT Filed: Jul. 11, 2023
(86) PCT No.: PCT/EP2023/069106

§ 371 Date: Jan. 17, 2025

Related U.S. Application Data
(60) Provisional application No. 63/390,329, filed on Jul. 19, 2022.

(30) Foreign Application Priority Data
Jul. 29, 2022 (EP) 22187748.3

(51) Int. Cl. H01H 9/02; H02G 3/14

(52) U.S. Cl. CPC H01H 9/0207; H02G 3/14; H01H 2223/044; H01H 2223/058; H01H 2231/052

(57) ABSTRACT

A wall station control unit includes a wall station housing and a keypad interface assembly having a keypad. The keypad interface assembly is adjustably attached to the wall station housing by a first fastener and a second fastener. The first fastener extends through a first fastener hole in the wall station housing, and the second fastener extends through a second fastener hole in the wall station housing. The first fastener and the second fastener are adjustable to change a spacing between the keypad interface assembly and the wall station housing to adjust a position of the keypad relative to the wall station housing.

### TECHNICAL FIELD

The present disclosure relates generally to lighting solutions, and in particular to a lighting control wall station with an adjustable position keypad.

### BACKGROUND

A lighting system may have multiple luminaires and a fixed wall station (e.g., a dimmer) that controls the luminaires. A wall station often has a keypad that is used by users to control the lighting provided by the luminaires. The keypad of a wall station is typically aligned with an opening of a wall plate of the wall station. Ideally, the keypad is not too far back or too far out with respect to the opening and the front surface (i.e., user-facing surface) of the wall plate. However, the keypad may sometimes be in an undesirable depth position relative to the front surface of the wall plate. In some cases, a misaligned attachment of the wall station to an in-wall electrical box may result in a depth misalignment of the keypad relative to the front surface of the wall plate. In some other cases, the wall around an installed wall station may be uneven and may result in the wall plate being unevenly attached to the rest of the wall station. In yet some other cases, variations in the thickness of wall plates from different manufacturers may result in a keypad being too far in or too far out with respect to the front surface of a wall plate depending on the thickness of the particular wall plate. Thus, a solution that enables the adjustment of the depth position of the keypad of a wall station may be desirable.

### SUMMARY

In general, the present disclosure relates to lighting solutions, and in particular to a lighting control wall station with an adjustable position keypad. In an example embodiment, a wall station control unit includes a wall station housing and a keypad interface assembly having a keypad. The keypad interface assembly is adjustably attached to the wall station housing by a first fastener and a second fastener. The first fastener extends through a first fastener hole in the wall station housing, and the second fastener extends through a second fastener hole in the wall station housing. The first fastener and the second fastener are adjustable to change a spacing between the keypad interface assembly and the wall station housing to adjust a position of the keypad relative to the wall station housing.

In another example embodiment, a wall station includes a wall plate and a control unit, where the wall plate is removably attached to the control unit. The control unit includes a wall station housing and a keypad interface assembly having a keypad. The keypad interface assembly is adjustably attached to the wall station housing by a first fastener and a second fastener. The first fastener extends through a first fastener hole in the wall station housing, and the second fastener extends through a second fastener hole in the wall station housing. The first fastener and the second fastener are adjustable to change a spacing between the keypad interface assembly and the wall station housing to adjust a position of the keypad relative to the wall plate.

These and other aspects, objects, features, and embodiments will be apparent from the following description and the claims.

### BRIEF DESCRIPTION OF THE DRAWINGS

Reference will now be made to the accompanying figures, which are not necessarily to scale, and wherein:

FIG. 1 illustrates a wall station with an adjustable depth position keypad according to an example embodiment;

FIG. 2 illustrates the wall station of FIG. 1 with a wall plate detached from the control unit of the wall station according to an example embodiment;

FIG. 3 illustrates an exploded view of the wall station of FIG. 1 according to an example embodiment;

FIGS. 4A and 4B illustrate different exploded views of the wall station of FIG. 1 according to an example embodiment;

FIG. 5 illustrates the control unit of the wall station of FIG. 1 according to an example embodiment;

FIG. 6 illustrates the keypad interface assembly of the wall station of FIG. 1 according to an example embodiment;

FIGS. 7A and 7B illustrate close-up views of a fastener attachment area of the keypad interface assembly of FIG. 6 according to an example embodiment;

FIGS. 8A and 8B illustrate different views of the screws used for attaching the keypad interface assembly according to an example embodiment;

FIG. 9 illustrates a use of a tool to adjust the position of the keypad interface assembly of the wall station of FIG. 1 according to an example embodiment; FIGS. 10 and 11 illustrate the control unit of the wall station of FIG. 1 with the keypad interface assembly adjusted to different positions according to an example embodiment;

FIGS. 12 and 13 illustrate the wall station of FIG. 1 with the keypad interface assembly adjusted to the different depth positions shown in FIGS. 10 and 11 according to an example embodiment; and

FIGS. 14 and 15 illustrate different views of a control unit of FIG. 1 that has screws for a vertical tilt adjustment of the keypad according to another example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the figures, reference numerals designate like or corresponding, but not necessarily identical, elements.

### DETAILED DESCRIPTION OF THE EXAMPLE EMBODIMENTS

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

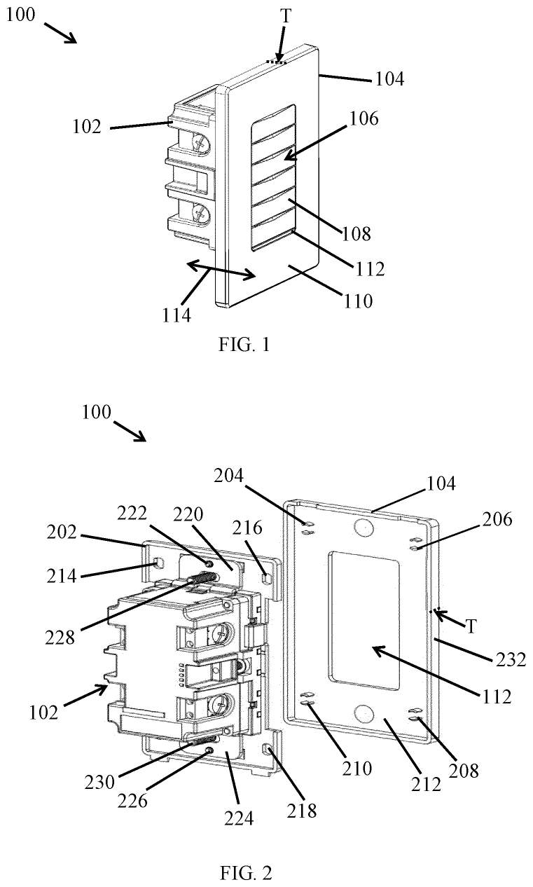

FIG. 1 illustrates a wall station 100 with an adjustable depth position keypad 108 according to an example embodiment. For example, the wall station 100 may be a dimmer or another lighting control device. In some example embodiments, the wall station 100 may be used to control one or more light fixtures. The wall station 100 may include a control unit 102 and a wall plate 104 attached to the control unit 102. The control unit 102 may include a keypad interface assembly 106 that includes the keypad 108. The keypad 108 may be located at an opening 112 of the wall plate 104. A user may use the keypad 108 to provide inputs to the wall station 100. For example, the wall station 100 may transmit lighting control commands to light fixtures in response to a user input provided via the keypad 108. In general, a user can provide inputs to the wall station 100 by pushing/pressing on keys of the keypad 108.

In some example embodiments, the position of the keypad interface assembly 106 may be adjusted in the directions shown by the bidirectional arrow 114. Changing the position of the keypad interface assembly 106 results in changing the depth position of the keypad 108 relative to a front surface 110 of the wall plate 104. The depth position of the keypad 108 may be adjusted in the directions shown by the bidirectional arrow 114 by adjusting the position of the keypad interface assembly 106 as described below in more detail. For example, the depth position of the keypad 108 may be adjusted such that the keypad 108 is flush with the front surface 110 of the wall plate 104. The depth position of the keypad 108 may also be adjusted such that the keypad 108 is farther back or farther forward relative to the front surface 110 of the wall plate 104.

In some example embodiments, the thickness T of the wall plate 104 can vary within a thickness range. For example, the thickness T of the wall plate 104 may depend on the manufacturer and/or the specific model of the wall plate 104. The adjustability of the depth position of the keypad 108 provides the flexibility to use the control unit 102 with the wall plate 104 regardless of the thickness T of the wall plate 104. To illustrate, the depth position of the keypad 108 can be adjusted such that the keypad 108 is at the same desired position relative to the front surface 110 of the wall plate 104. For example, the depth position of the keypad 108 may be adjusted such that the keypad 108 is flush with the front surface 110 of the wall plate 104 regardless of the thickness T of the wall plate 104. The control unit 102 may be designed such that the range of the adjustability of the depth position of the keypad 108 at least matches the range of variations in the thickness T of the wall plate 104.

In some example embodiments, in addition to accommodating wall stations of various thickness, the adjustability of the depth position of the keypad 108 can also provide an option to avoid and remedy improper installations of wall stations to an in-wall electrical box or to another structure. The adjustability of the depth position of the keypad 108 can also provide an option to avoid and remedy improper installation issues such as those related to the installation of wall stations in uneven walls.

In some alternative embodiments, the wall station 100 including the wall plate 104 may have a different shape than shown in FIG. 1 without departing from the scope of this disclosure. For example, the perimeter of the wall plate 104 may have different shape than shown without departing from the scope of this disclosure. In some alternative embodiments, the keypad 108 may have more or fewer keys/buttons than shown without departing from the scope of this disclosure. In some alternative embodiments, the keypad 108 may have different keys/buttons and/or configurations of keys/buttons without departing from the scope of this disclosure. In some alternative embodiments, the keypad 108 may have keys/buttons that extend out from a base as can be readily understood by those of ordinary skill in the art with the benefit of this disclosure.

FIG. 2 illustrates the wall station 100 of FIG. 1 with the wall plate 104 detached from the control unit 102 of the wall station 100 according to an example embodiment. Referring to FIGS. 1 and 2, in some example embodiments, the control unit 102 may include a back plate 202 to which the wall plate 104 can be removably attached. The wall plate 104 may include snaps 204, 206, 208, 210 that extend out from a back surface 212 (i.e., the surface facing the control unit 102) of the wall plate 104. The snaps 204, 206, 208, 210 may be aligned with and inserted into corresponding receiving holes in the back plate 202 to retain the wall plate 104 attached to the back plate 202 and thus to the control unit 102. For example, the back plate 202 may include receiving holes 214, 216, 218 that are respectively aligned with the snaps 204, 206, 208. The back plate 202 may also include another receiving hole that is aligned with the snap 210 protruding out from the back surface 212 of the wall plate 104.

In some example embodiments, the perimeter lip 232 of the wall plate 104 may be positioned around the perimeter edge of the back plate 202 when the wall plate 104 is attached to the back plate 202. The wall plate 104 may be removed from the back plate 202, for example, by prying the wall plate 104 off using a finger or a small tool (e.g., a flat screwdriver) as can be readily understood by those of ordinary skill in the art with the benefit of this disclosure.

In some example embodiments, the back plate 202 may be attached to a bracket 220 of the control unit 102 by a fastener 222 (e.g., a screw), and the back plate 202 may be attached to a bracket 224 of the control unit 102 by a fastener 226 (e.g., a screw). The brackets 220, 224 may be attached to the wall station housing that may be at least partially positioned in an in-wall electrical box (not shown) when the wall station 100 is installed. The control unit 102 may be attached to an electrical box using fasteners 228 and 230 (e.g., screws) that extend through holes in the brackets 220 and 224, respectively. The fasteners 228, 230 are designed to retain the control unit 102 firmly attached to an electrical box.

In some alternative embodiments, the wall plate 104 may be attached to the back plate 202 using other means instead or in addition to the snaps 204, 206, 208, 210. In some alternative embodiments, the snaps 204, 206, 208, 210 and the corresponding holes in the back plate 202 may be at different locations than shown without departing from the scope of this disclosure. In some alternative embodiments, other means instead of or in addition to the fasteners 228, 230 may be used to attach the control unit 102 to an electrical box using. In some alternative embodiments, the opening 112 may have a different shape than shown without departing from the scope of this disclosure.

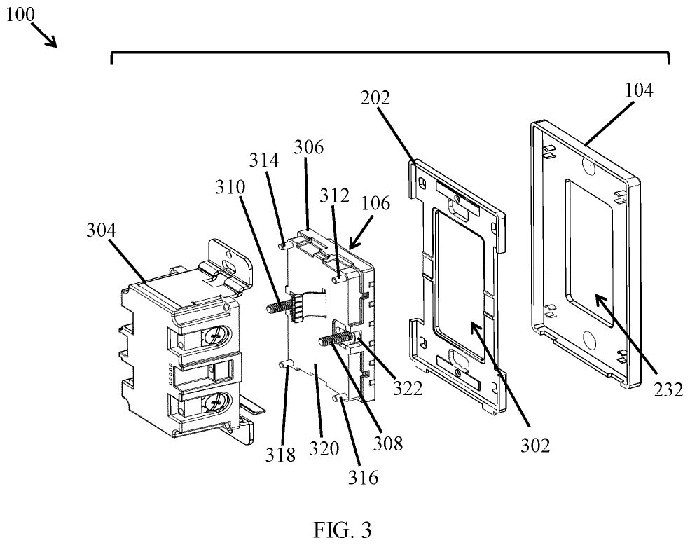

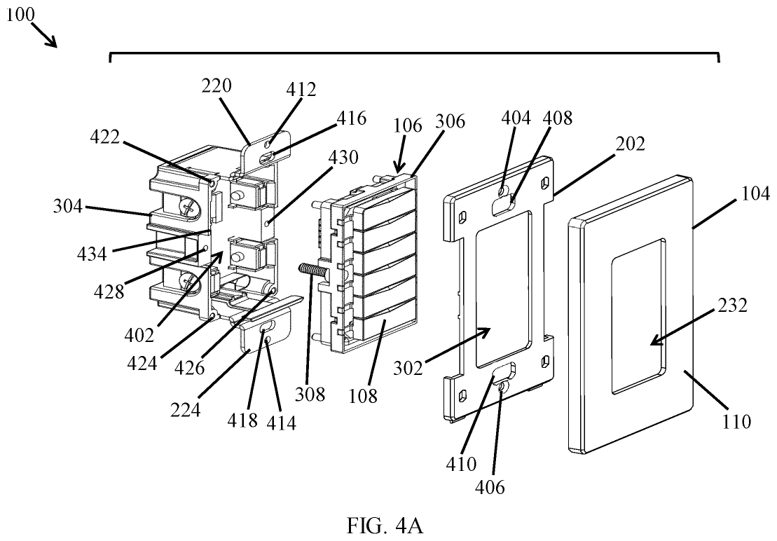

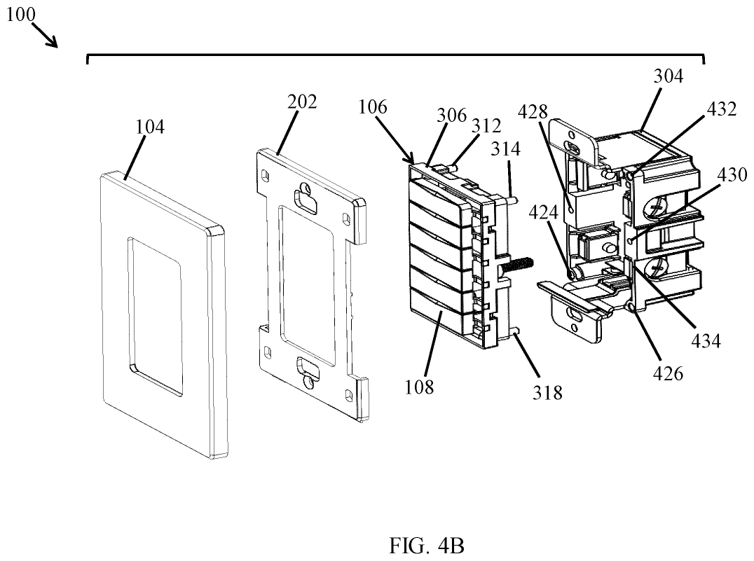

FIGS. 3, 4A, and 4B illustrate exploded views of the wall station 100 of FIG. 1 according to an example embodiment. Referring to FIGS. 1-4B, in some example embodiments, the back plate 202 may have an opening 302 that is aligned with the opening 112 of the wall plate 104. The keypad 108 may be located at the opening 302 of the back plate 202. For example, a portion of the keypad 108 may extend through the opening 302.

In some example embodiments, the wall station 100 includes a wall station housing 304, and the keypad interface assembly 106 may include a keypad interface assembly housing 306. The keypad interface assembly 106 may be attached to the wall station housing 304 by fasteners. For example, the keypad interface assembly 106 may be attached to the wall station housing 304 by screws 308, 310. The screws 308, 310 may be attached to the keypad interface assembly housing 306 and may be accessible for adjustment from the front side of the keypad interface assembly 106 facing the back plate 202 and the wall plate 104. For example, the screw 308 may include a screw head that is positioned in a screw slot of the keypad interface assembly housing 306. The tool slot of the screw head may be accessible from the front side of the keypad interface assembly 106 for adjustment by a tool (e.g., a screwdriver). The screw 310 may also include a screw head that is positioned in another screw slot of the keypad interface assembly housing 306.

In some example embodiments, the wall station housing 304 may include fastener holes 428, 430 that are aligned with the screws 308, 310, respectively, that are, for example, threaded holes. The screw 308 may be inserted into the fastener hole 418 and the screw 310 may be inserted into the fastener hole 430 to adjustably attach the keypad interface assembly housing 306 to the wall station housing 304.

In some example embodiments, the screws 308, 310 may each be positioned in the respective one of the fastener holes 428, 430 such that the back wall 320 of the keypad interface assembly housing 306 is in contact with (i.e., not spaced from) the wall station housing 304. For example, the back wall 320 of the keypad interface assembly housing 306 may be in contact with a front perimeter edge 434 of the wall station housing 304. While positioned in the fastener holes 428, 430, the screws 308, 310 may also be adjusted such that the back wall 320 of the keypad interface assembly housing 306 is separated from the front perimeter edge 434 of the wall station housing 304. The size of the separation between the keypad interface assembly housing 306 and the wall station housing 304 (i.e., between the back wall 320 of the keypad interface assembly housing 306 and the front perimeter edge 434 of the wall station housing 304 that includes the fastener holes 428, 430) may be changed by adjusting the screws 308, 310 while the screws 308, 310 are positioned in the fastener holes 428, 430. Because the keypad interface assembly 106 includes the keypad 108, changing (i.e., increases and decreases) the size of the separation between the keypad interface assembly housing 306 and the wall station housing 304, changes the position of the keypad 108 relative to the wall station housing 304. The depth position of the keypad 108 relative to the front surface 110 of the wall plate 104 can be changed by changing the size of the separation (i.e., the spacing) between the keypad interface assembly housing 306 and the wall station housing 304.

In some example embodiments, the screws 308, 310 may be on different sides (e.g., right side and left side) of the keypad interface assembly 106 and may be adjusted independent of each other. The screws 308, 310 may be adjusted to extend outside of the respective one of the fastener holes 428, 430 by the same or substantially (e.g., not readily noticeable by a person) the same length. For example, the screws 308, 310 may be adjusted such that the separation between the keypad interface assembly housing 306 and the wall station housing 304 is the same or substantially the same at the screws 308, 310. The size of separation between the keypad interface assembly housing 306 and the wall station housing 304 may be adjusted to be the same or substantially the same not just at the screws 308, 310 but also for the entirety of the perimeter edge 434 of wall station housing 304.

In some example embodiments, one or both of the screws 308, 310 may be adjusted such that the screws 308, 310 extend outside of the respective one of the fastener holes 428, 430 by different lengths. For example, the screws 308, 310 may be adjusted such that the size of the separation between the keypad interface assembly housing 306 and the wall station housing 304 is different at the screws 308, 310. To illustrate, the screws 308, 310 may be adjusted such that the separation between the back wall 320 of the keypad interface assembly housing 306 and the perimeter edge 434 of the wall station housing 304 may be larger at the screw 308 than at the screw 310 or vice versa. In general, the screws 308, 310 may be adjusted such that the separation between the keypad interface assembly 106 and the wall station housing 304 is different on one side (e.g., right side) of the keypad interface assembly 106 than on the other side (e.g., left side) of the keypad interface assembly 106. For example, differences in the separation between the wall station housing 304 and the keypad interface assembly housing 306 at opposite sides of the keypad interface assembly 106 may be desirable to compensate, for example, for an uneven wall or a horizontally uneven installation of an electrical box to which the wall station housing 304 may be attached.

In some example embodiments, the keypad interface assembly 106 may include pins 312, 314, 316, 318 that protrude out from a back wall 320 of the keypad interface assembly housing 306. The pins 312, 314, 316, 318 may be aligned with respective alignment holes in the wall station housing 304. For example, the wall station housing 304 may include alignment holes 422, 424, 426, 432 that are aligned with the pins 312, 314, 316, 318, respectively.

In some example embodiments, the pins 312, 314, 316, 318 may be inserted in the respective alignment holes of the wall station housing 304. For example, during the process of attaching of the keypad interface assembly 106 to the wall station housing 304, the pins 312, 314, 316, 318 along with the alignment holes may serve as guides for the proper alignment of the keypad interface assembly 106 with the wall station housing 304. In some alternative embodiments, the pins 312, 314, 316, 318 and the alignment holes 422, 424, 426, 432 of the wall station housing 304 may be threaded, and the pins may be accessible from the front side of the keypad interface assembly 106 for adjustment. For example, the pins 312, 314, 316, 318 may be set screws (e.g., long-nosed set screws) and may be adjusted to achieve different separation sizes between the wall station housing 304 and the keypad interface assembly housing 306 at the top and bottom sides of the keypad interface assembly 106. For example, the pins 312, 314, 316, 318 may be long-nosed set screws, where the portion of each set screw positioned in the respective one of the alignment holes 422, 424, 426, 432 is not threaded and where the portion of each set screw outside of the alignment holes 422, 424, 426, 432, including the portion extending through the keypad interface assembly housing 306, may be threaded. Different separation sizes between the wall station housing 304 and the keypad interface assembly housing 306 at opposite sides of the keypad interface assembly 106 may be desirable to compensate, for example, for an uneven wall or a vertically uneven installation of an electrical box to which the wall station housing 304 may be attached.

In some example embodiments, the back plate 202 includes a hole 404, and the bracket 220 includes a hole 412. The fastener 222 shown in FIG. 2 may extend through the holes 404 and 412 to attach the back plate 202 to the bracket 220. The back plate 202 includes a hole 406, and bracket 224 may include a hole 414. The fastener 226 shown in FIG. 2 may extend through the holes 406 and 414 to attach the back plate 202 to the bracket 224.

In some example embodiments, the back plate 202 includes a hole 408, and the bracket 220 includes a hole 416. The fastener 228 shown in FIG. 2 may extend through the holes 408 and 416 and may be used to securely attach the control unit 102 to an electrical box (not shown). The back plate 202 may include a hole 410, and bracket 224 may include a hole 418. The fastener 230 shown in FIG. 2 may extend through the holes 410 and 418 and may be used to securely attach the control unit 102 to the same electrical box.

In some example embodiments, the wall station housing 304 and the keypad interface assembly housing 306 may be made from one or more suitable materials (e.g., plastic) using methods such as molding, cutting, and/or drilling as can be readily understood by those of ordinary skill in the art with the benefit of this disclosure. The wall plate 104 and the back plate 202 may also be made from one or more suitable materials (e.g., plastic) using methods such as molding, cutting, and/or drilling as can be readily understood by those of ordinary skill in the art with the benefit of this disclosure. The keypad 108 may be attached to the keypad interface assembly housing 306 using means such as snaps and/or other fasteners as can be readily understood by those of ordinary skill in the art with the benefit of this disclosure.

By adjusting the separation/spacing between the back wall 320 of the keypad interface assembly housing 306 and the front perimeter edge 434 of the wall station housing 304 that includes the fastener holes 428, 430, the depth position of the keypad 108 relative to the front surface 110 of the wall plate 104 can be adjusted as needed based on the thickness T of the perimeter lip 232 of wall plate 104. The adjustability of the depth position of the keypad 108 can expand the choice of manufactures of the wall plate 104. The adjustability of the depth position of the keypad 108 also allows the customization of the wall station 100 by changing the type of the wall plate 104. In addition to the expanded choice of wall plate manufacturers, the adjustability of the depth position of the keypad 108 can result in avoiding and remedying wall station installation issues related an uneven wall, an unevenly installed in-wall electrical box, and other similar issues.

In some example embodiments, the independent adjustability of the screws 308, 310 can result in the keypad 108 having a depth position that compensates, for example, for a horizontally uneven wall or a horizontally unevenly installed electrical box. For example, a horizontal 1 to 2 degrees tilt of the keypad 108 may be sufficient to compensate for horizontally uneven wall surfaces and installations. In embodiments where the pins 312, 314, 316, 318 are set screws, the independent adjustability of the pins 312, 314, 316, 318 can result in the keypad 108 having a depth position that compensates, for example, for a vertically uneven wall or a vertically unevenly installed electrical box. For example, a vertical 1 to 2 degrees tilt of the keypad 108 may be sufficient to compensate for vertically uneven wall surfaces and installations. Using two screws (i.e., the screws 308, 310) instead of just one screw and placing the screws 308, 310 on opposite sides (e.g., right side and left side) of the keypad interface assembly 106 can provide more stability of the keypad 108 when the keys of the keypad 108 are pressed/pushed by a user.

In some alternative embodiments, a portion of the keypad interface assembly 106 may be inside the cavity 402 of the wall station housing 304. For example, the back wall 320 of the keypad interface assembly housing 306 may have different sections where one or more sections are inside the cavity 402 and one or more portions (e.g., where the screws 308, 310 are located) are outside the cavity 402. In some alternative embodiments, the screws 308, 310 and the fastener holes 428, 430 may be at different locations than shown without departing from the scope of this disclosure. In some alternative embodiments, the pins 312, 314, 316, 318 and the alignment holes 422, 424, 426, 432 may be at different locations than shown without departing from the scope of this disclosure. In some alternative embodiments, one or more components of the wall station 100 may have a different shape than shown without departing from the scope of this disclosure.

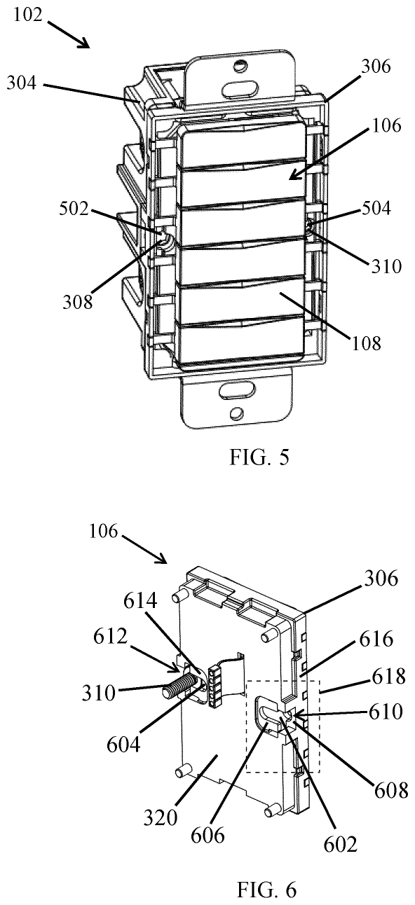

FIG. 5 illustrates the control unit 102 of the wall station 100 of FIG. 1 according to an example embodiment. Referring to FIGS. 1-5, in some example embodiments, the control unit 102 includes the keypad interface assembly 106 that is adjustably attached to the wall station housing 304 by the screws 308, 310. The screws 308, 310 are accessible for adjustment from the front side of the keypad interface assembly 106. For example, the keypad interface assembly 106 may have an access opening 502 for accessing the screw 308, for example, for adjustment by a tool, such as a screwdriver. The access opening 502 may be formed, for example, in the keypad interface assembly housing 306 of the keypad interface assembly 106. The keypad interface assembly 106 may also have an access opening 504 for accessing the screw 310, for example, for adjustment by a tool, such as a screwdriver. The access opening 504 may be formed, for example, in the keypad interface assembly housing 306 of the keypad interface assembly 106.

As describe above, the depth position of the keypad 108 may be adjusted by adjusting the screws 308, 310. For example, turning the screws 308, 310 clockwise can move the keypad interface assembly housing 306 closer to the wall station housing 304 and turning the screws 308, 310 counterclockwise can move the keypad interface assembly housing 306 away from to the wall station housing 304, or vice versa. Moving the keypad interface assembly housing 306 closer to or away from the wall station housing 304 can change the depth position of the keypad 108 relative to the front surface 110 of the wall plate 104 as can be readily understood by those of ordinary skill in the art with the benefit of this disclosure.

In some alternative embodiments, the access openings 502, 504 may be larger or smaller than shown in FIG. 5 without departing from the scope of this disclosure. In some alternative embodiments, the access openings 502, 504 may have a different shape than shown in FIG. 5 without departing from the scope of this disclosure. In some alternative embodiments, the access openings 502, 504 and the screws 308, 310 may be at different locations than shown in FIG. 5 without departing from the scope of this disclosure.

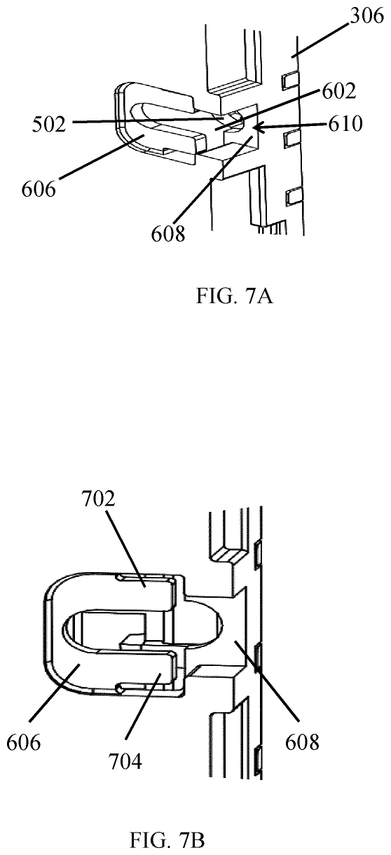

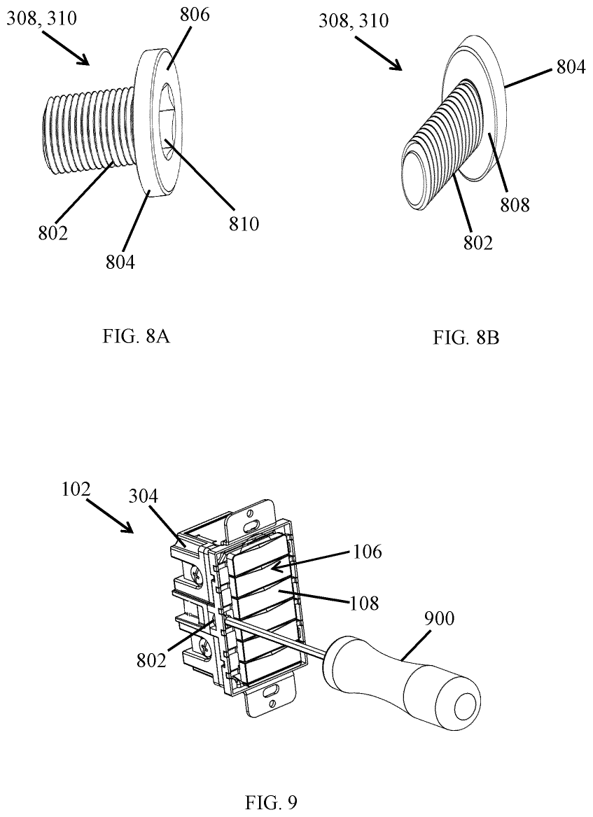

FIG. 6 illustrates the keypad interface assembly 206 of the wall station 100 of FIG. 1 according to an example embodiment, FIGS. 7A and 7B illustrate close-up view of a fastener attachment area (shown inside a dotted box 618 in FIG. 6) of the keypad interface assembly 106 of FIG. 6 according to an example embodiment. FIGS. 8A and 8B illustrate different views of the screws 308, 310 used for attaching the keypad interface assembly 106 according to an example embodiment. As shown in FIGS. 8A and 8B, the screws 308, 310 may each include a threaded shaft 802 and a screw head 804. The screw head 804 may have a front surface 806 and a back surface 808, where the threaded shaft 802 extends out from the back surface 808. The screw head 804 may also include a tool slot 810, such as a slot for inserting the tip of a screwdriver.

Referring to FIGS. 1-8B, in some example embodiments, the keypad interface assembly 106 includes the keypad interface assembly housing 306 that includes slots 602, 604. For example, the screw head 804 of the screw 308 may be positioned in the slot 602, and the screw head 804 of the screw 310 may be positioned in the slot 604. The screw 308 is omitted from FIGS. 7 and 8 for clarity of illustration.

In some example embodiments, the keypad interface assembly housing 306 may include openings 610, 612 that provide access to the slots 602, 604, respectively, of the keypad interface assembly housing 306. For example, the screw 308 may be slid into the slot 602 through the opening 610, and the screw 310 may be slid into the slot 604 through the opening 612. The openings 610, 612 may be formed in the side wall 616 of the keypad interface assembly housing 306 and/or the back wall 320 of the keypad interface assembly housing 306.

In some example embodiments, the screw 308 may be retained in the slot 602 by retaining wall sections 606, 608. For example, the front surface 806 of the screw head 804 may be in contact with the retaining wall section 608, and the back surface 808 of the screw head 804 of the screw 308 may be in contact with the retaining wall section 606. To illustrate, the slot 602 may be sized such that, when the screw head 804 of the screw 308 is in the slot 602, the retaining wall section 606, which may be elastic, exerts a force (e.g., an elastic force) on the screw head 804 of the screw 308 to retain the screw head 804 of the screw 308 in contact with the retaining wall section 608. For example, portions 702, 704 of the retaining wall section 606 may be attached on one side and unattached on a number of other sides as shown more clearly in FIG. 7B. To illustrate, in some example embodiments, the retaining wall section 606 may be U-shaped, where the threaded shaft 802 of the screw 308 extends out between the legs of the U-shape that include the portions 702, 704.

In some example embodiments, the screw 310 may be retained in the slot 604 in the same manner as described above with respect to the screw 308 and the slot 602. For example, a retaining wall section 614, which may be elastic, may exert pressure on the screw head 804 of the screw 310 to retain the screw head 804 of the screw 310 in contact with the retaining wall section at the slot 604 corresponding to the retaining wall section 608 at the slot 602. The retaining wall section 614 may be U-shaped, where the threaded shaft 802 of the screw 308 extends out between the legs of the U-shape.

After the screw head 804 of the screw 308 is positioned in the slot 602, a screwdriver may be used to drive the threaded shaft 802 of the screw 308 into the fastener hole 428 shown in FIG. 4. For example, the tip of a screwdriver may be inserted into the tool slot 810 of the screw head 804 of the screw 308 through the access opening 502. After the screw head 804 of the screw 310 is positioned in the slot 604 as shown in FIG. 8A, a screwdriver may be used to drive the threaded shaft 802 of the screw 310 into the fastener hole 430 shown in FIG. 4. For example, the tip of a screwdriver may be inserted into the tool slot 810 of the screw head 804 of the screw 310 through the access opening 504 shown in FIG. 5. As described above, the depth position of the keypad 108 may be adjusted by adjusting the screws 308, 310 after the screws are inserted in the fastener holes 428, 430, respectively, shown in FIG. 4.

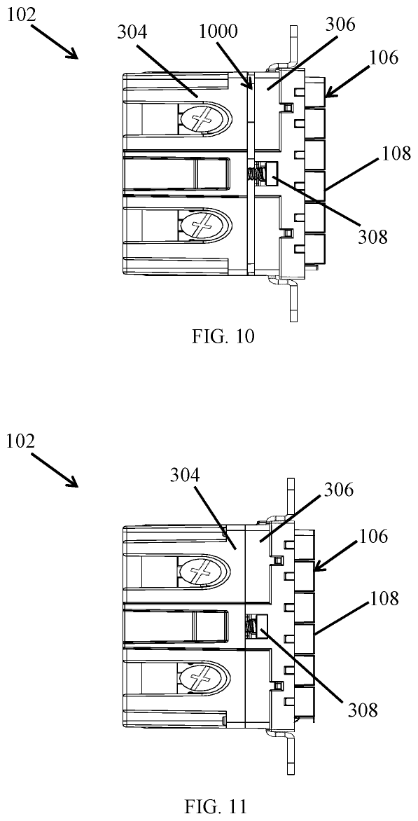

For example, FIG. 9 illustrates a use of a tool 900 (e.g., a screwdriver) to adjust the position of the keypad interface assembly 106 of the wall station 100 of FIG. 1 according to an example embodiment. Referring to FIGS. 1-9, in some example embodiments, the back plate 202 may be unattached or detached from the brackets 220, 224 to access the screw head 804 of the screw 308. The tip of the tool 900 may be inserted in the tool slot 810 of the screw head 804 of the screw 308. The tool 900 may be used to adjust the screw 308 by turning the screw 308 clockwise and/or counterclockwise as needed, which can result in changing the position of the keypad interface assembly 106 relative to the wall station housing 304. That is, the tool 900 may be used to adjust the screw 308 to change the depth position of the keypad 108 relative to the wall plate 104. The tool 900 may also be used to turn the screw 310 in the same manner as described with respect to the screw 308. For example, the tool 900 may be used to repeated adjust the screws 308, 310 in turn until a desired depth position of the keypad 108 is achieved. Alternatively, two of the tool 900 may be used simultaneously to adjust the screws 308, 310.

By positioning the head 804 of each of the screws 308, 310 in the respective one of the slots 602, 604 as described above, the keypad interface assembly 106 along with the keypad 108 can be moved toward and away from the wall station housing 304 by turning the screws 308, 310. By retaining the head 804 of the screw 308 in contact with the retaining wall section 608 and by retaining the head 804 of the screw 310 in contact with the retaining wall section of the slot 604 corresponding to the retaining wall section 608, unintended movements (e.g., rattles) of the keypad interface assembly 106 can be avoided, for example, when a user presses/pushes the keypad 108 during the use of the wall station 100.

In some alternative embodiments, the screws 308, 310 may have a different shape than shown without departing from the scope of this disclosure. In some alternative embodiments, the slots 602, 604 may be at different locations than shown without departing from the scope of this disclosure. In some alternative embodiments, the retaining wall sections 606, 608 and the corresponding retaining wall sections, including the retaining wall section 614, at the slot 604 of the keypad interface assembly housing 306 may have other shapes and configurations without departing from the scope of this disclosure. In some alternative embodiments, the openings 610, 612 may be omitted or at different locations than shown without departing from the scope of this disclosure. For example, the screw head 804 of each of the screws 308, 310 may be inserted into the respective one of the slots 602, 604 through another opening that is, for example, in the back wall 320 of the keypad interface assembly housing 306 or on the front side of the keypad interface assembly housing 306. In some alternative embodiments, the retaining wall sections 606, 614 may not be elastic. In some alternative embodiments, other elastic components (e.g., coil springs) may be used instead of or in addition to the retaining wall sections 606, 614 being elastic.

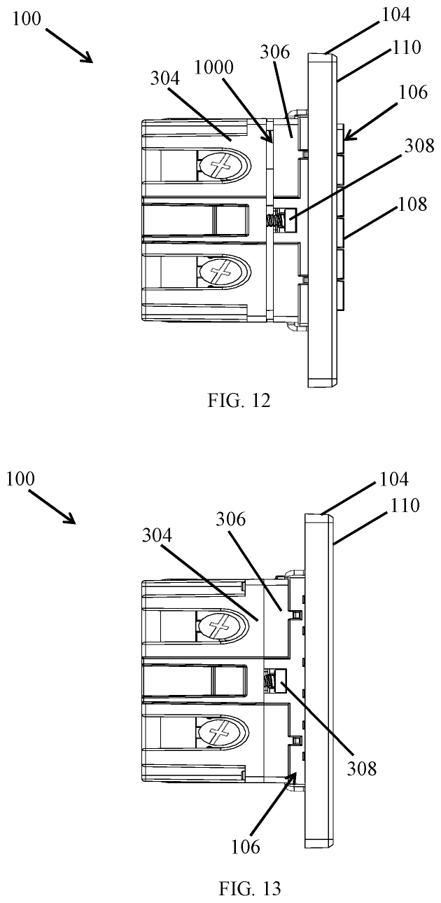

FIGS. 10 and 11 illustrate the control unit 102 of the wall station 100 of FIG. 1 with the keypad interface assembly 106 adjusted to different positions according to an example embodiment, and FIGS. 12 and 13 illustrate the wall station of FIG. 1 with the keypad interface assembly adjusted to the different depth positions shown in FIGS. 10 and 11 according to an example embodiment. Referring to FIGS. 1-13, in some example embodiments, the screws 308, 310 can be adjusted as described above such the wall station housing 304 and the keypad interface assembly housing 306 of the keypad interface assembly 106 are separated by a spacing 1000 as shown in FIGS. 10 and 12. That is, the depth position of the keypad 108 relative to the front surface 110 of the wall plate 104 may be adjusted such that the keypad 108 extends beyond the front surface 110 of the wall plate 104 as more clearly shown in FIG. 12.

In some example embodiments, the screws 308, 310 may be adjusted as described above such that the spacing 1000 is closed off as more clearly shown in FIGS. 11 and 13. For example, the keypad 108 may be flush with the front surface 110 of the wall plate 104 or farther back toward the wall station housing 304 from the front surface 110 when the spacing 1000 is closed off as shown in FIGS. 11 and 13. In general, the screws 308, 310 may be adjusted to close off the spacing 1000 and to change size of the spacing 1000 to adjust the depth position of the keypad 108 in a range of depth positions relative to the front surface 110. As described above, a horizontal tilt of the keypad interface assembly 106 along with the keypad 108 may be achieved by varying the adjustment of the screws 308, 310. In embodiments where the pins 312, 314, 316, 318 are set screws as described above, a vertical tilt of the keypad interface assembly 106 along with the keypad 108 may be achieved.

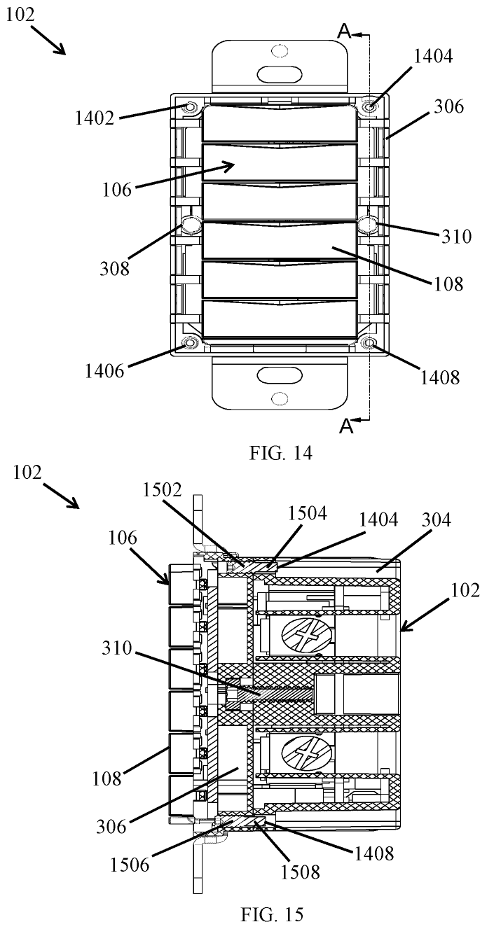

FIGS. 14 and 15 illustrate the control unit 102 of FIG. 1 that has screws 1402, 1404, 1406, 1408 for a vertical tilt adjustment of the keypad 108 according to another example embodiment. In particular, FIG. 15 illustrates a cross-sectional view of the control unit 102 along the A-A line shown in FIG. 14 according to another example embodiment. Referring 1, 14, and 15, in some example embodiments, the control unit 102 in FIGS. 14 and 15 includes set screws 1402, 1404, 1406, 1408 instead of the pins 312, 314, 316, 318 shown, for example, in FIG. 3. For example, each set screw may include a threaded portion that is in a respective set screw hole of the keypad housing 306 and a non-threaded section that is in the respective one of the alignment holes 422, 424, 426, 432 of the wall station housing 304. For example, the set screw 1404 may include a threaded portion 1502 and a non-threaded portion 1504, and the set screw 1408 may include a threaded portion 1506 and a non-threaded portion 1508. To illustrate, the non-threaded portion 1504 of the set screw 1404 may be in the alignment hole 432 shown in FIG. 4B, and the non-threaded portion 1504 of the set screw 1408 may be in the alignment hole 426 shown in FIG. 4B.

In some example embodiments, in addition to adjustments of the position of the keypad 108 by adjusting the screws 308, 310 as described above, a vertical tilt of the keypad interface assembly 106 along with the keypad 108 may be achieved. The individual adjustability of the set screws 1402, 1404, 1406, 1408 can result in the keypad 108 having a depth position that compensates, for example, for a vertically uneven wall or a vertically unevenly installed electrical box. For example, a vertical 1 to 2 degrees tilt of the keypad 108 may be sufficient to compensate for typical vertically uneven wall surfaces and installations.

In some alternative embodiments, the set screws 1402, 1404, 1406, 1408 may each be another type of screw without departing from the scope of this disclosure. In some alternative embodiments, the set screws 1402, 1404, 1406, 1408 may each be fully threaded without departing from the scope of this disclosure. In some alternative embodiments, the set screws 1402, 1404, 1406, 1408 may be at different locations than shown without departing from the scope of this disclosure.

Although particular embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the scope of the following claims, the scope of which are to be accorded the broadest interpretation so as to encompass modifications and equivalent structures.

1. A wall station control unit, comprising:
a wall station housing sized to fit in an in-wall electrical box in a wall; and
a keypad interface assembly having a keypad sized to fit in an opening of a wall plate, wherein the keypad interface assembly is adjustably attached to the wall station housing by a first fastener and a second fastener, wherein the first fastener extends through a first fastener hole in the wall station housing, wherein the second fastener extends through a second fastener hole in the wall station housing, and wherein the first fastener and the second fastener are adjustable to change a spacing between the keypad interface assembly and the wall station housing, wherein an adjustment to the first fastener and the second fastener adjusts a depth position of the keypad relative to a front surface of the wall plate independent of adjustment between the wall station housing and the in-wall electrical box.

2. The wall station control unit of claim 1, wherein a keypad interface assembly comprises a keypad interface assembly housing, wherein the first fastener hole and the second fastener hole are formed through a perimeter edge of the wall station housing, and wherein the spacing between the keypad interface assembly and the wall station housing is between the keypad interface assembly housing and the perimeter edge of the wall station housing.

3. The wall station control unit of claim 1, wherein the keypad interface assembly comprises a keypad interface assembly housing, wherein the first fastener is a screw having a screw head and a threaded shaft, and wherein the screw head is positioned between a first retaining wall section of the keypad interface assembly housing and a second retaining wall section of the keypad interface assembly housing.

4. The wall station control unit of claim 3, wherein the first retaining wall section is elastic and wherein the first retaining wall section retains the screw head in contact with the second retaining wall section.

5. The wall station control unit of claim 3, wherein the second fastener is a second screw comprising a second screw head and a second threaded shaft and wherein the second screw head is positioned between a third retaining wall section of the keypad interface assembly housing and a fourth retaining wall section of the keypad interface assembly housing.

6. The wall station control unit of claim 5, wherein the screw head of the first fastener and the second screw head of the second fastener are accessible from a front side of the keypad interface assembly housing that is to adjust the first fastener and the second fastener.

7. The wall station control unit of claim 3, wherein the first fastener and the second fastener are adjustable such that a back wall of the keypad interface assembly housing is in contact with the wall station housing closing off the spacing.

8. The wall station control unit of claim 3, wherein one or more pins extending out from the keypad interface assembly housing are inserted in one or more respective alignment holes in the wall station housing.

9. The wall station control unit of claim 1, wherein the first fastener and the second fastener are independently adjustable.

10. The wall station control unit of claim 9, wherein the first fastener and the second fastener are on opposite sides of the keypad interface assembly and wherein the keypad interface assembly may be horizontally tilted by differently adjusting the first fastener and the second fastener.

11. A wall station, comprising:
a wall plate; and
a control unit, wherein the wall plate is removably attached to the control unit, the control unit comprising:
a wall station housing sized to fit in an in-wall electrical box in a wall; and
a keypad interface assembly having a keypad sized to fit in an opening of the wall plate), wherein the keypad interface assembly is adjustably attached to the wall station housing by a first fastener and a second fastener, wherein the first fastener extends through a first fastener hole in the wall station housing, wherein the second fastener extends through a second fastener hole in the wall station housing, and wherein the first fastener and the second fastener are adjustable to change a spacing between the keypad interface assembly and the wall station housing, wherein an adjustment to the first fastener and the second fastener adjusts a depth position of the keypad relative to a front surface of the wall plate independent of adjustment between the wall station housing and the in-wall electrical box.

12. The wall station of claim 11, wherein the keypad interface assembly comprises a keypad interface assembly housing, wherein the first fastener is a screw having a screw head and a threaded shaft, and wherein the screw head is positioned between a first retaining wall section of the keypad interface assembly housing and a second retaining wall section of the keypad interface assembly housing.

13. The wall station of claim 12, wherein the second fastener is a second screw comprising a second screw head and a second threaded shaft, wherein the second screw head is positioned between a third retaining wall section of the keypad interface assembly housing and a fourth retaining wall section of the keypad interface assembly housing.

14. The wall station of claim 12, wherein the first retaining wall section is elastic and wherein the first retaining wall section retains the screw head in contact with the second retaining wall section.

15. The wall station of claim 11, wherein the first fastener and the second fastener are accessible for adjustment by removing a back plate of the wall station housing and the wall plate and wherein the wall plate is removably attached to the back plate of the wall station housing.
